(19) United States
(12) Patent Application Publication
(10) Pub. No.: US 2015/0236974 A1
(43) Pub. Date: Aug. 20, 2015

(54) COMPUTER SYSTEM AND LOAD BALANCING METHOD

(71) Applicant: HITACHI, LTD., Chiyoda-ku, Tokyo (JP)

(72) Inventors: Shunsuke Minamitake, Tokyo (JP); Yasufumi Uchiyama, Tokyo (JP)

(73) Assignee: Hitachi, Ltd., Tokyo (JP)

(21) Appl. No.: 14/428,178

(22) PCT Filed: Apr. 26, 2013
(86) PCT No.: PCT/JP2013/062414

§ 371 Date: Mar. 13, 2015

(51) Int. Cl. H04L 12/911; H04L 29/08

(52) U.S. Cl. CPC H04L 47/726; H04L 67/1004

(57) ABSTRACT

A computer system and a load balancing method dynamically and efficiently balances the load of management servers. An aggregation server receives a task to be executed by a plurality of management servers that manage storage apparatuses divides the received task into a plurality of sub tasks, and sequentially determines the management server with the lowest load as the destination of the sub task. The aggregation sever manages all resources that are used by the plurality of sub tasks that use a common resource as a resource group. When one of the sub tasks has previously been input into the management server that was determined as the input destination of the sub task, one of the sub tasks to use the resource in the resource group is determined as the sub task to be input into that management server.

### TECHNICAL FIELD

The present invention relates to a computer system and a load balancing method, and in particular can be suitably applied to a computer system comprising a plurality of management servers for managing a storage apparatus.

### BACKGROUND ART

Conventionally, a computer system is provided with one management server for one storage apparatus. With this kind of conventional computer system, in cases where the configuration of the storage apparatus is to be changed; for instance, when the logical volume provided by the storage apparatus is to be newly assigned to the host computer, the computer is configured such that, by setting a task corresponding to the contents of the configuration change in the management server associated with that storage apparatus, the configuration of the storage apparatus is changed based on the control of the management server.

Meanwhile, in recent years, the number of storage apparatuses that are installed in data centers and other locations is drastically increasing pursuant to the increase in the amount of data that is being handled by corporations and the like. Under these circumstances, in recent years, demanded is the configuration of a scheme in which one storage apparatus can be distributively managed by a plurality of management servers, rather than providing one management server for one storage apparatus.

In response to the foregoing demand, for instance, PTL 1 describes technology which enables the management of one storage apparatus by a plurality of management servers.

### CITATION LIST

### Patent Literature

### PTL 1

Japanese Patent Application Publication No. 2012-155544

### SUMMARY OF INVENTION

### Technical Problem

However, with PTL 1, since one storage apparatus is managed by a plurality of management servers based on the static configuration information of the storage apparatus, there is a problem in that the load of the management server cannot be dynamically balanced. Moreover, according to the technology disclosed in PTL 1, the load can only be balanced in task units, and there is a problem in that the load balancing cannot be performed in smaller units.

The present invention was devised in view of the foregoing points, and an object of this invention is to propose a computer system and a load balancing method capable of dynamically and efficiently balancing the load of the management servers.

### Solution to Problem

In order to achieve the foregoing object, the present invention provides, in a computer system including one or more storage apparatuses, a plurality of management servers that are associated with the one or more storage apparatuses, and which manage resources of the associated storage apparatuses, and an aggregation server that receives a task to be executed by the management servers. The aggregation server divides the received task into a plurality of sub tasks as a minimum unit of processing, makes an inquiry to each of the management servers regarding a number of the sub tasks, among the plurality of divided sub tasks, that can be executed between a start time and an end time that were set for the original task before being divided, acquires, from each of the management servers that can execute at least one of the sub tasks, a load status of each of the management servers, and determines an input destination of each of the sub tasks so that the load of each of the management servers is balanced based on the acquired load status of each of the management servers and an answer from each of the management servers in response to the inquiry, and inputs each of the sub tasks into the input destination management server according to a determination result. When a management server does not possess resource information of the resource to be used by the sub task that was input from the aggregation server, that management server acquires resource information of the resource from the management server that is managing that resource, and thereafter executes the input sub task. The aggregation server sequentially determines the management server with a lowest load as the input destination of the sub task upon determining the input destination of each of the sub tasks, manages all resources that are respectively used by the plurality of sub tasks that use a common resource as a resource group, and, when one of the sub tasks to use the resource belonging to the resource group has previously been input into the management server that was determined as the input destination of the sub task, one of the sub tasks to use the resource in the resource group, to which the resource to be used by that sub task belongs, is determined as the sub task to be input into that management server.

The present invention additionally provides a load balancing method of balancing a load of management servers in a computer system including one or more storage apparatuses, and a plurality of management servers that are associated with the one or more storage apparatuses, and which manage resources of the associated storage apparatuses. The computer system includes an aggregation server that receives a task to be executed by the management servers, and comprises a first step of the aggregation server dividing the received task into a plurality of sub tasks as a minimum unit of processing, a second step of the aggregation server making an inquiry to each of the management servers regarding a number of the sub tasks, among the plurality of divided sub tasks, that can be executed between a start time and an end time that were set for the original task before being divided, a third step of the aggregation server acquiring, from each of the management servers that can execute at least one of the sub tasks, a load status of each of the management servers, and determining an input destination of each of the sub tasks so that the load of each of the management servers is balanced based on the acquired load status of each of the management servers and an answer from each of the management servers in response to the inquiry, a fourth step of the aggregation server inputting each of the sub tasks into the input destination management server according to a determination result, and a fifth step of, when a management server does not possess resource information of the resource to be used by the sub task that was input from the aggregation server, that management server acquiring resource information of the resource from the management server that is managing that resource, and thereafter executing the input sub task. In the third step, the aggregation server sequentially determines the management server with a lowest load as the input destination of the sub task upon determining the input destination of each of the sub tasks, manages all resources that are respectively used by the plurality of sub tasks that use a common resource as a resource group, and, when one of the sub tasks to use the resource belonging to the resource group has previously been input into the management server that was determined as the input destination of the sub task, one of the sub tasks to use the resource in the resource group, to which the resource to be used by that sub task belongs, is determined as the sub task to be input into that management server.

According to the foregoing computer system and load balancing method, it is possible to shorten the time required for a management server to acquire, from another management server, resource information that is required for executing the input sub tasks.

### Advantageous Effects of Invention

According to the present invention, it is possible to realize a computer system and a load balancing method capable of dynamically and efficiently balancing the load of the management servers.

### BRIEF DESCRIPTION OF DRAWINGS

FIG. 1 is a block diagram showing the overall configuration of the computer system according to this embodiment.

FIG. 2 is a block diagram showing the schematic configuration of the host computer.

FIG. 3 is a block diagram showing the schematic configuration of the storage apparatus.

FIG. 4 is a block diagram showing the schematic configuration of the management server.

FIG. 5 is a block diagram showing the schematic configuration of the aggregation server.

FIG. 6 is a block diagram showing the logical configuration of the aggregation server and the management server.

FIG. 7 is a conceptual diagram showing the configuration of the management server management table.

FIG. 8 is a conceptual diagram showing the configuration of the resource management table.

FIG. 9 is a conceptual diagram showing the configuration of the task management table.

FIG. 10 is a conceptual diagram showing the configuration of the aggregation server sub task management table.

FIG. 11 is a conceptual diagram showing the configuration of the resource group management table.

FIG. 12 is a conceptual diagram showing the configuration of the management server sub task management table.

FIG. 13 is a conceptual diagram showing the configuration of the sub task average execution time management table.

FIG. 14 is a schematic diagram showing the schematic configuration of the volume assignment screen.

FIG. 15 is a schematic diagram showing the schematic configuration of the detailed sub task screen.

FIG. 16 is a schematic diagram showing the schematic configuration of the warning screen.

FIG. 17 is a schematic diagram showing the schematic configuration of the task status screen.

FIG. 18 is a flowchart showing the processing routine of the resource information collection processing.

FIG. 19 is a flowchart showing the processing routine of the number of inputtable sub tasks confirmation processing.

FIG. 20 is a flowchart showing the processing routine of the number of executable sub tasks return processing.

FIG. 21 is a flowchart showing the processing routine of the sub task input destination determination and input processing.

FIG. 22 is a flowchart showing the processing routine of the sub task input destination determination processing.

FIG. 23 is a flowchart showing the processing routine of the resource group creation processing.

FIG. 24 is a flowchart showing the processing routine of the resource information acquisition processing.

FIG. 25 is a conceptual diagram explaining another embodiment.

### DESCRIPTION OF EMBODIMENTS

An embodiment of the present invention is now explained in detail with reference to the drawings.

### (1) Configuration of Computer System According to this Embodiment

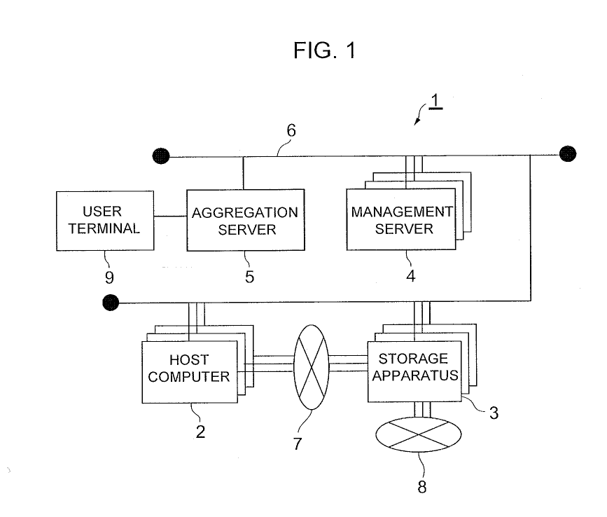

In FIG. 1, reference numeral 1 indicates the overall computer system according to this embodiment. The computer system 1 is configured by comprising one or more host computers 2, one or more storage apparatuses 3, one or more management servers 4, and an aggregation server 5, and these components are connected to each other via a management LAN (Local Area Network) 6. Moreover, the respective host computers 2 and the respective storage apparatuses 3 are connected to each other via a host communication SAN (Storage Area Network) 7, and the respective storage apparatuses 3 are connected to each other via an inter-apparatus communication SAN 8. In addition, a user terminal 9 is connected to the aggregation server 5.

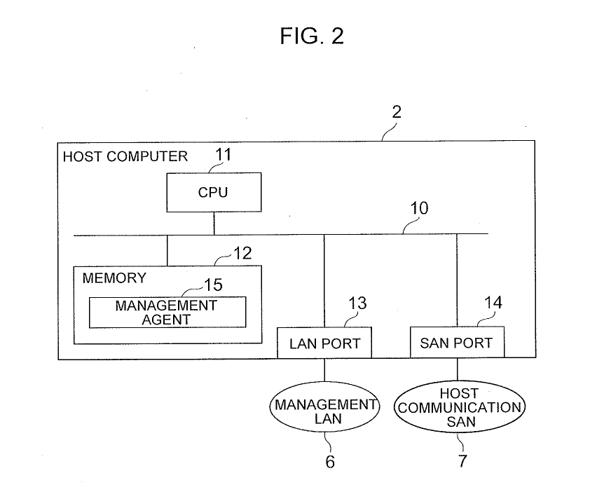

The host computer 2 is a computer device that issues write requests and read requests to the storage apparatuses 3 according to the user's operations or requests from installed application software, and, as shown in FIG. 2, comprises a CPU (Central Processing Unit) 11, a memory 12, a LAN port 13 and a SAN port 14 that are connected to each other via an internal bus 10.

The CPU 11 is a processor that governs the operational control of the overall host computer 2. Moreover, the memory 12 is configured, for example, from a semiconductor memory, and is mainly used for storing various programs. As a result of the CPU 11 executing the programs stored in the memory 12, various types of processing, which are to be executed by the overall host computer 2, are executed. The memory 12 also stores a management agent 15 that periodically or randomly collects various types of configuration information of the own host computer 2 and notifies the management server 4.

The LAN port 13 is a physical interface for connecting the host computer 2 to the management LAN 6, and is assigned a unique address on the management LAN 6. Moreover, the SAN port 14 is a physical interface for connecting the host computer 2 to the host communication SAN 7, and is assigned a unique address on the host communication SAN 7.

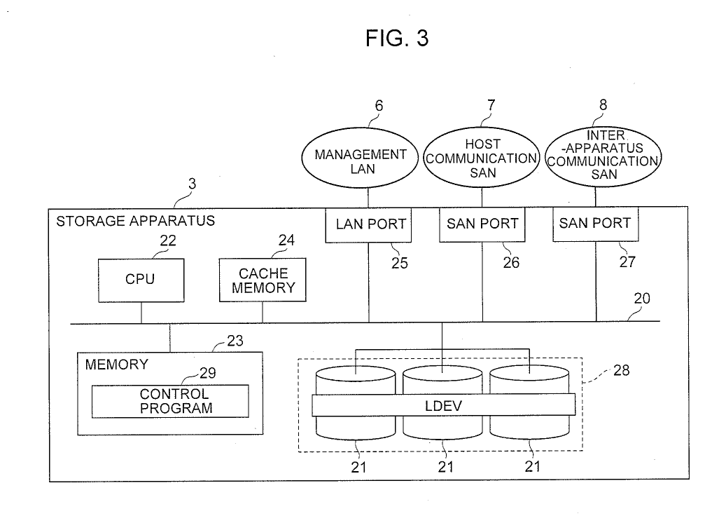

The storage apparatus 3 is a storage that provides a storage area, which is used for storing data, to the host computer 2, and, as shown in FIG. 3, comprises a plurality of physical storage devices 21, a CPU 22, a memory 23, a cache memory 24, a LAN port 25, a first SAN port 26 and a second SAN port 27 that are connected to each other via an internal bus 20.

The physical storage device 21 is configured, for example, from an expensive disk such as a SCSI (Small Computer System Interface) disk or an inexpensive disk such as a SATA (Serial AT Attachment) disk or an optical disk. One RAID (Redundant Arrays of Inexpensive Disks) group 28 is configured from one or more physical storage devices 21, and one or more logical volumes LDEV are set on a physical storage area that is provided by the respective physical storage devices 21 configuring the one RAID group 28. In addition, data from the host computer 2 is stored in the logical volumes LDEV in units of a block of a predetermined size (this is hereinafter referred to as the “logical block”).

The logical volumes LDEV are each assigned a unique identifier (this is hereinafter referred to as the “volume ID”). In the case of this embodiment, the input/output of data is performed by using a combination of the volume ID and a number that is assigned to each of the logical blocks and unique to that logical block (LBA: Logical Block Address) as the address, and designating that address.

The CPU 22 is a processor that governs the operational control of the overall storage apparatus 3. Moreover, the memory 23 is configured, for example, from a semiconductor memory, and is mainly used for storing various control programs 29. As a result of the CPU 22 executing the control programs 29 stored in the memory 23, various types of processing, such as reading and writing data from and into the logical volumes LDEV, are executed. Moreover, the cache memory 24 is used for temporarily storing and retaining data to be read from and written into the logical volumes LDEV.

The LAN port 25 is a physical interface for connecting the storage apparatus 3 to the management LAN 6, and is assigned a unique address on the management LAN 6. Moreover, the first SAN port 26 is a physical interface for connecting the storage apparatus 3 to the host communication SAN 7, and is assigned a unique address on the host communication SAN 7. Similarly, the second SAN port 27 is a physical interface for connecting the storage apparatus 3 to the inter-apparatus communication SAN 8, and is assigned a unique address on the inter-apparatus communication SAN 8.

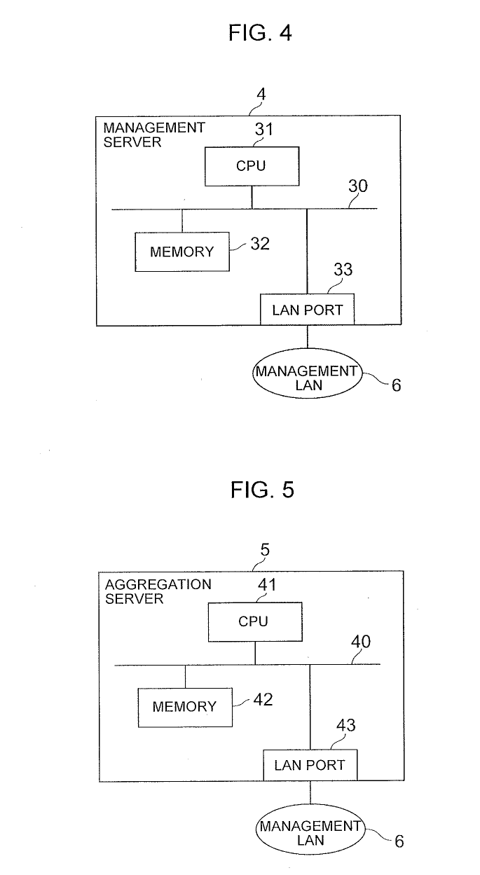

The management server 4 is a server apparatus that is used for managing the storage apparatuses 3, and, as shown in FIG. 4, comprises a CPU 31, a memory 32 and a LAN port 33 that are connected to each other via an internal bus 30. The CPU 31 is a processor that governs the operational control of the overall management server 4. Moreover, the memory 32 is configured, for example, from a semiconductor memory, and is mainly used for storing various programs. As a result of the CPU 31 executing the programs stored in the memory 32, various types of processing, which are to be executed by the overall management server 4, are executed. The LAN port 33 is a physical interface for connecting the management server 4 to the management LAN 6, and is assigned a unique address on the management LAN 6.

The aggregation server 5 is a server apparatus with a function of assigning the tasks, which were set by a user, to the management servers 4, and, as shown in FIG. 5, comprises a CPU 41, a memory 42 and a LAN port 43 that are connected to each other via an internal bus 30.

The CPU 41 is a processor that governs the operational control of the overall aggregation server 5. Moreover, the memory 42 is configured, for example, from a semiconductor memory, and is mainly used for storing various programs. As a result of the CPU 41 executing the programs stored in the memory 42, various types of processing, which are to be executed by the overall aggregation server 5, are executed. The LAN port 43 is a physical interface for connecting the aggregation server 5 to the management LAN 6, and is assigned a unique address on the management LAN 6.

The user terminal 9 is a computer device that is used for configuring various settings in the storage apparatuses 3 and setting various tasks in the management servers 4. The user terminal 9 comprises input devices such as a keyboard and a mouse for the user to input various commands, and an output device for displaying various types of information and a GUI (Graphical User Interface).

### (2) Logical Configuration of Aggregation Server and Management Server

The load balancing function provided in the computer system 1 is now explained. The computer system 1 is equipped with a load balancing function to seek the load balancing of the respective management servers 4 based on dynamic information, or tasks, set by the user.

In effect, with the computer system 1, the aggregation server 5 divides the task registered by the user into a plurality of sub tasks, and assigns these sub tasks to the respective management servers 4 so as to balance the load of the respective management servers 4.

Here, a sub task refers to the smallest unit of processing configuring the task. For example, in the case of a task of assigning the three logical volumes of “LDEV1” to “LDEV3” to the host computer 2 named “HostA”, this task can be divided into a first task of assigning “LDEV1” to “HostA”, a second task of assigning “LDEV2” to “HostA”, and a third task of assigning “LDEV3” to “HostA”. Thus, these dividable first to third tasks are the sub tasks of the task of assigning the three logical volumes of “LDEV1” to “LDEV3” to the host computer 2 named “HostA”.

When the management server 4 to which the sub task was assigned does not possess resource information required for executing that sub task, that management server 4 acquires the resource information from another management server 4, and uses the acquired resource information to execute that sub task. Note that the term “resource” refers to the processing target to execute the sub task. For example, in the sub task of assigning “LDEV1” to “HostA”, both “HostA” and “LDEV1” are resources that are required for executing the sub task.

Here, the aggregation server 5 manages all resources that are respectively used by the plurality of sub tasks that use a common resource as a resource group, and manages the identifying information of the respective resources configuring the resource group as resource group information. Here, the expression of “use a common resource” includes a case of all sub tasks using the same resource, as well as a case where all sub tasks are not using the same resource, but the individual sub tasks are using a resource that is the same as at least one resource that is being used by at least one other sub task. The same applies in the ensuing explanation.

When the aggregation server 5 assigns a sub task to a management server 4, in order to shorten the time required for that management server 4 to acquire resource information from another management server 4, the aggregation server 5 refers to the resource group information and assigns that sub task to the management server 4 so as to balance the load of the respective management servers 4 and give preference to the management server 4 holding the most resource information required for executing the sub task to be assigned.

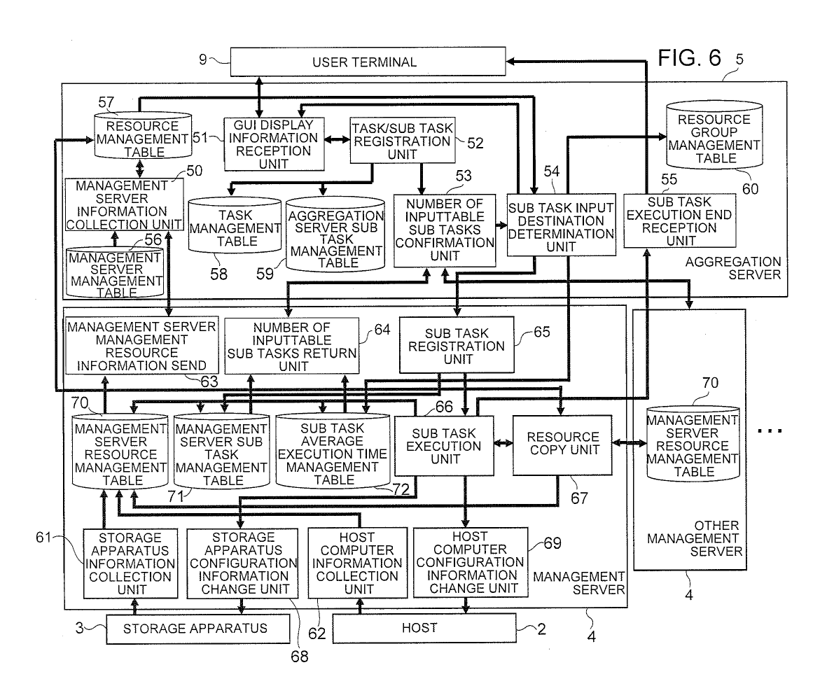

As means for realizing the load balancing function according to this embodiment as described above, the memory 42 (FIG. 5) of the aggregation server 5 stores, as shown in FIG. 6, a management server information collection unit 50, a GUI display information reception unit 51, a task/sub task registration unit 52, a number of inputtable sub tasks confirmation unit 53, a sub task input destination determination unit 54 and a sub task execution end reception unit 55 as programs, and additionally stores a management server management table 56, a resource management table 57, a task management table 58, an aggregation server sub task management table 59 and a resource group management table 60 as tables.

The management server information collection unit 50 is a program with a function of collecting, from the respective management servers 4, the configuration information of the host computer 2 and the storage apparatus 3 that were collected by the respective management servers 4 from the host computer 2 and the storage apparatus 3. The management server information collection unit 50 registers, in the resource management table 57, information related to the resources managed by the respective management servers 4 based on the collected configuration information.

The term “resource” refers to the constituent elements of the host computer 2 and the storage apparatus 3 to be managed by the management servers 4. For example, the host computer 2 itself, and the logical volumes, the RAID group 28, and the respective ports (LAN port 25 and first and second SAN ports 26, 27) in the storage apparatus 3 correspond to resources.

The GUI display information reception unit 51 is a program with a function of displaying, on the user terminal 9, various GUI screens such as the GUI screen for setting the tasks to be executed by the management servers 4. When a user sets a new task by using the GUI screen, the GUI display information reception unit 51 notifies information of that task (this is hereinafter referred to as the “task information”) to the task/sub task registration unit 52.

The task/sub task registration unit 52 is a program with a function of registering, in the task management table 58, the task information of the task that was newly set by the user, and registering, in the aggregation server sub task management table 59, information of the respective sub tasks that is obtained as a result of dividing the task into a plurality of sub tasks (this is hereinafter referred to as the “sub task information”). The task/sub task registration unit 52 registers the sub task information of the respective sub tasks in the aggregation server sub task management table 59, and notifies the sub task information to the number of inputtable sub tasks confirmation unit 53.

The number of inputtable sub tasks confirmation unit 53 is a program with a function of making an inquiry to the respective management servers 4, upon receiving the sub task information of the respective sub tasks of the newly set task notified from the task/sub task registration unit 52, regarding how many of the sub tasks among these sub tasks can be completed within the execution period that was set for the original task (this is hereinafter referred to as the “setup execution period”). In addition, the number of inputtable sub tasks confirmation unit 53 notifies the sub task input destination determination unit 54 of the answers from the respective management servers 4 in response to the inquiry (this is hereinafter referred to as the “inquiry on number of inputtable sub tasks”).

The sub task input destination determination unit 54 is a program with a function of deciding which sub task should be input into which management server 4 based on the answers from the respective management servers in response to the foregoing inquiry on number of inputtable sub tasks notified from the number of inputtable sub tasks confirmation unit 53, and information which is stored in the resource management table 57 and related to the resources being managed by each of the management servers (this is hereinafter referred to as the “resource information”). The sub task input destination determination unit 54 requests the target management server 4 to execute the corresponding sub task according to the determination result (this is hereinafter referred to as “inputting the sub task”).

The sub task execution end reception unit 55 is a program with a function of notifying the end of execution of the sub task. When the sub task execution end reception unit 55 receives a notice from the management server 4, into which the sub task was input by the sub task input destination determination unit 54, to the effect that the execution of that sub task has ended, the sub task execution end reception unit 55 notifies the user terminal 9 to such effect.

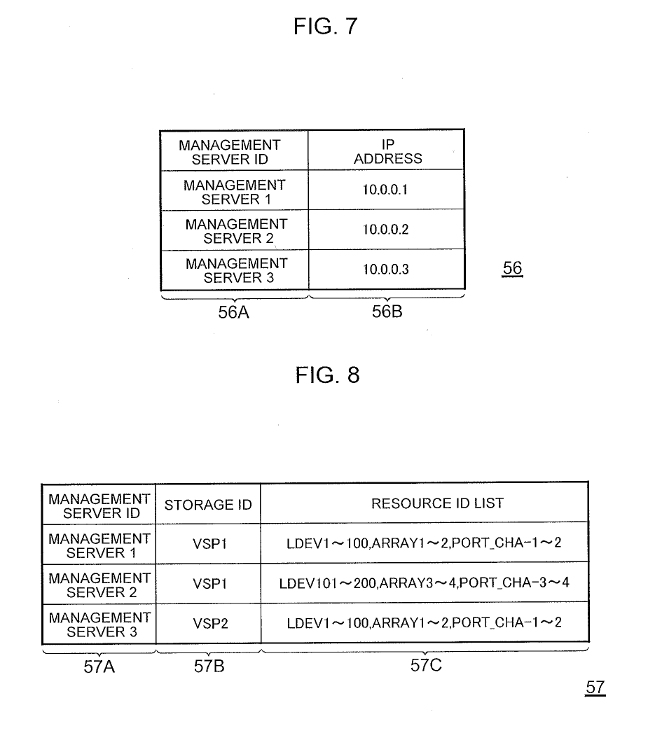

Moreover, the management server management table 56 is a table that is used by the aggregation server 5 for managing the management servers 4, and is configured, as shown in FIG. 7, from a management server ID column 56A and an IP address column 56B. The management server ID column 56A stores the identifying information (management server ID) of the respective management servers 4 that are managed by the aggregation server 5, and the IP address column 56B stores the IP address on the management LAN 6 (FIG. 1) of the corresponding management server 4.

Accordingly, the example of FIG. 7 shows that the aggregation server 5 is managing three management servers 4 named “management server 1”, “management server 2” and “management server 3”, and the IP address on the management LAN 6 of the management server 4 named “management server 1” is “10.0.0.1”.

The resource management table 57 is table that is used by the aggregation server 5 for managing which resources are being managed by the respective management servers 4, and is configured, as shown in FIG. 8, from a management server ID column 57A, a storage ID column 57B and a resource ID list column 57C.

The management server ID column 57A stores the management server ID of the respective management servers 4 that are being managed by the aggregation server 5, and the storage ID column 57B stores the identifying information (storage ID) of the storage apparatuses 3 that are being managed by those management servers 4. Moreover, the resource ID list column 57C stores a list of the identifying information (resource ID) of the respective resources in the corresponding storage apparatus 3 that is being managed by the corresponding management server 4.

Accordingly, the example of FIG. 8 shows that the management server 4 named “management server 1” is managing the respective logical volumes named “LDEV1 to LDEV100” of the storage apparatus 3 named “VSP1”, the RAID group 28 (FIG. 3) named “ARRAY1 to 2”, and the port named “PORT CHA-1 to 2”.

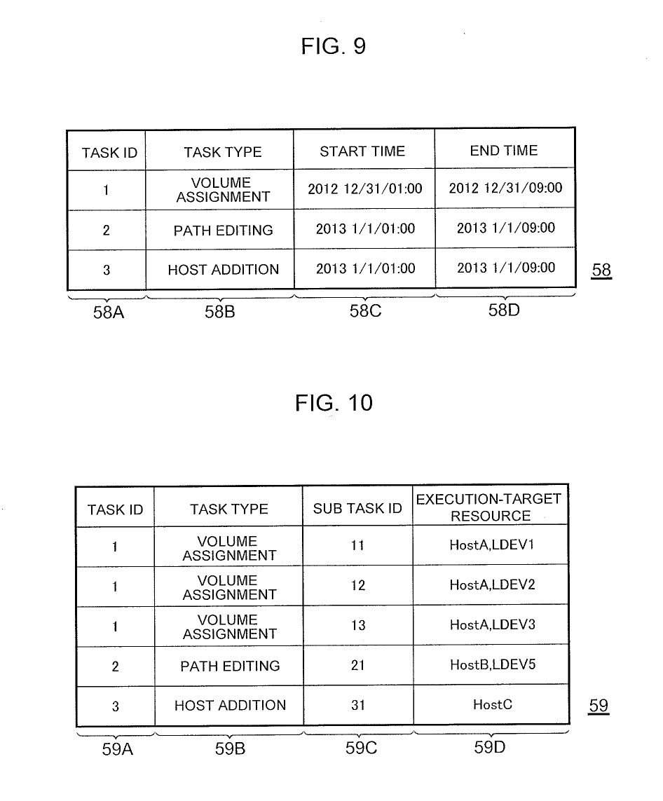

The task management table 58 is a table that is used for managing the tasks that were set by the user, and is configured, as shown in FIG. 9, from a task ID column 58A, a task type column 58B, a task start time column 58C and a task end time column 58D.

The task ID column 58A stores the identifying information (task ID) for each task that is assigned when a task is set by the user, and the task type column 58B stores the type of the corresponding task (volume assignment, path editing, host addition, or the like). Moreover, the task start time column 58C stores the time that the corresponding task that was set by the user should be started, and the task end time column 58D stores the time that the corresponding task that was set by the user should be ended.

Accordingly, the example of FIG. 9 shows that the type of task that was assigned the task ID of “1” is “volume assignment”, and that task was set to be started at “2012 12/31/01:00” and end at “2012 12/31/09:00”.

The aggregation server sub task management table 59 is a table that is used for managing the sub tasks, and is configured, as shown in FIG. 10, from a task ID column 59A, a task type column 59B, a sub task ID column 59C and an execution-target resource column 59D.

The task ID column 59A stores the task ID of the original task of the corresponding sub tasks, and the task type column 59B stores the type of the corresponding sub task. Moreover, the sub task ID column 59C stores the identifying information (sub task ID) of the sub task that was assigned to the corresponding sub task, and the execution-target resource column 59D stores the resource ID of the respective resources to become the execution-target of the corresponding sub task.

Accordingly, the example of FIG. 10 shows that the task that was assigned the task ID of “1” is divided into the three sub tasks of “11”, “12” and “13” in which the type thereof is “volume assignment”, and the resources to become the execution-target of the sub task that was assigned the sub task ID of “11” are “HostA” and “LDEV1”.

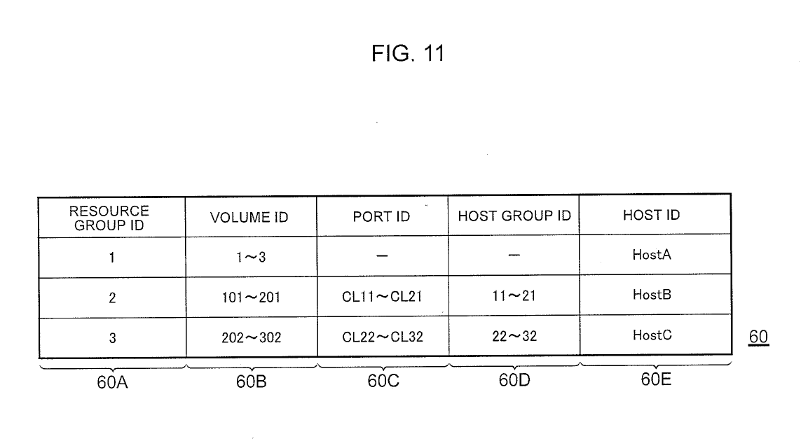

The resource group management table 60 is a table that is used for managing the created resource group, and is configured, as shown in FIG. 11, from a resource group ID column 60A, an LDEV ID column 60B, a port ID column 60C, a host group ID column 60D and a host ID column 60E.

The resource group ID column 60A stores the identifying information (resource group ID) of the resource group that was assigned by the aggregation server 5 to the corresponding resource group, and the LDEV ID column 60B stores, when a logical volume belongs to the corresponding resource group, the volume ID of that logical volume.

The port ID column 60C stores, when a port belongs to the corresponding resource group, the port ID of that port, and the host group ID column 60D stores, when a host group belongs to the corresponding resource group, the host group ID of that host group. Note that the term “host group” refers to the aggregate of host computers 2 that is configured from one or more host computers 2. One or more host computers 2 are managed as one host group in order to collectively manage the host computers of the same company or of the same business division of the same company. In addition, the host ID column 60E stores, when a host computer 2 belongs to the corresponding resource group, the host ID of that host computer 2.

Accordingly, the example of FIG. 11 shows that the logical volumes each assigned with the volume ID of “1 to 3” and the host computer 2 assigned with the host ID of “HostA” belong to the resource group having the resource group ID of “1”.

Meanwhile, as shown in FIG. 6, the memory 32 (FIG. 4) of the respective management servers 4 stores a storage apparatus information collection unit 61, a host computer information collection unit 62, a management server management resource information send unit 63, a number of inputtable sub tasks return unit 64, a sub task registration unit 65, a sub task execution unit 66, a resource copy unit 67, a storage apparatus configuration information change unit 68 and a host computer configuration information change unit 69 as programs, and additionally stores a management server resource management table 70, a management server sub task management table 71 and a sub task average execution time management table 72 as tables.

The storage apparatus information collection unit 61 is a program with a function of collecting the various types of configuration information of the storage apparatuses 3 from those storage apparatuses 3 that are being managed by the management server 4, and storing the collected configuration information in the management server resource management table 70. Similarly, the host computer information collection unit 62 is a program with a function of collecting the various types of configuration information of the host computers 2 from those host computers 2 that access the management server 4, and storing the collected configuration information in the management server resource management table 70.

Moreover, the management server management resource information send unit 63 is a program with a function of sending, to the management server information collection unit 50, the configuration information of the storage apparatuses 3 and the host computers 2 that are being managed by the own management server 4, which is stored in the management server resource management table 70, according to requests from the management server information collection unit 50 of the aggregation server 5.

In addition, the number of inputtable sub tasks return unit 64 is a program with a function of returning an answer to the foregoing inquiry on number of inputtable sub tasks from the aggregation server 5. When the number of inputtable sub tasks return unit 64 receives the inquiry on number of inputtable sub tasks issued from the number of inputtable sub tasks confirmation unit 53 of the aggregation server 5, the number of inputtable sub tasks return unit 64 refers to the management server sub task management table 71 and the sub task average execution time management table 72, determines the number of sub tasks that can be executed in the own management server 4 within the setup execution period of the original task, and returns the determination result as its answer to the number of inputtable sub tasks confirmation unit 53.

The sub task registration unit 65 is a program with a function of registering, in the management server sub task management table 71, the sub task that was input from the sub task input destination determination unit 54 of the aggregation server 5. When the sub task registration unit 65 registers the sub task in the management server sub task management table 71, the sub task registration unit 65 thereafter requests the sub task execution unit 66 to execute the registered sub task.

The sub task execution unit 66 is a program with a function of executing the corresponding sub task according to the sub task execution request from the sub task registration unit 65.

In effect, when the sub task execution unit 66 is requested by the sub task registration unit 65 to execute the sub task, the sub task execution unit 66 acquires, from the management server sub task management table 71, the sub task information of the sub task for which the execution request was received. Moreover, the sub task execution unit 66 acquires, from the management server resource management table 70, resource information of the resources required for executing the sub task, and uses the acquired resource information to execute that sub task. Note that, when the resource information required for executing the sub task is not registered in the management server resource management table 70, the sub task execution unit 66 requests the resource copy unit 67 to acquire the resource information.

Moreover, when the sub task execution unit 66 completes the execution of the sub task, the sub task execution unit 66 notifies such completion to the sub task execution end reception unit 55 of the aggregation server 5, and updates the sub task average execution time management table 72 based on the time that was required for executing that sub task. In addition, when the configuration of the host computer 2 or the storage apparatus 3 needs to be changed due to the execution of the sub task, the sub task execution unit 66 requests the host computer configuration information change unit 69 or the storage apparatus configuration information change unit 68 to change the configuration information of the host computer 2 or the storage apparatus 3 which is retained by the corresponding host computer 2 or storage apparatus 3.

The resource copy unit 67 is a program with a function of acquiring the resource information of necessary resources from the management server resource management table 70 of another management server 4 according to a request from the sub task execution unit 66, and copying the acquired resource information to the management server resource management table 70 in the own management server 4.

Moreover, the storage apparatus configuration information change unit 68 is a program with a function of updating the configuration information of the storage apparatus 3 retained by the corresponding storage apparatus 3 upon receiving a command from the sub task execution unit 66. Similarly, the host computer configuration information change unit 69 is a program with a function of updating the configuration information of the host computer 2 retained by the corresponding host computer 2 upon receiving a command from the sub task execution unit 66.

The management server resource management table 70 is a table that is used for managing the resource information of the respective resources that are being managed by the own management server 4, and stores the detailed resource information of these resources.

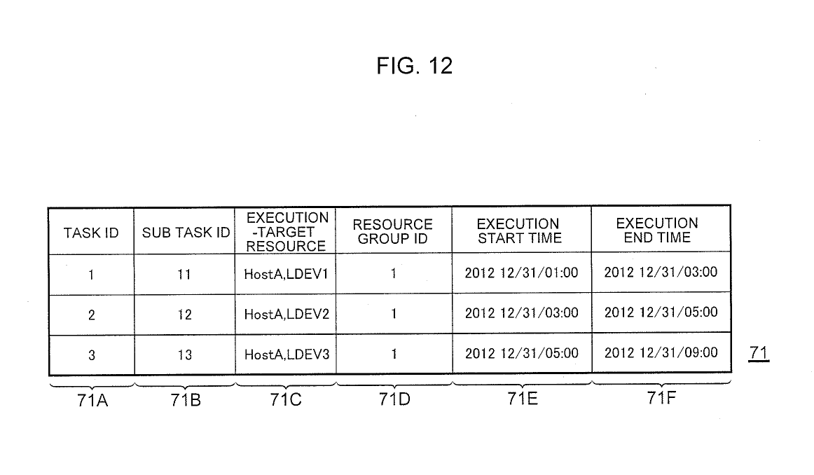

The management server sub task management table 71 is a table that is used by the management server 4 for managing the sub tasks that were input from the aggregation server 5, and is configured, as shown in FIG. 12, from a task ID column 71A, a sub task ID column 71B, an execution-target resource column 71C, a resource group ID column 71D, an execution start time column 71E and an execution end time column 71F.

The task ID column 71A stores the task ID of the original task of the corresponding sub task, and the sub task ID column 71B stores the sub task ID of the corresponding sub task. Moreover, the execution-target resource column 71C stores the resource ID of all resources to become the execution-target of the corresponding sub task, and the resource group ID column 71D stores the resource group ID of the resource group to which these resources belong. In addition, the execution start time column 71E and the execution end time column 71F respectively store the execution start time or the execution end time of the corresponding sub task that was determined by the sub task input destination determination unit 54 of the aggregation server 5.

Accordingly, the example of FIG. 12 shows that the execution-target resources of the sub task assigned with the sub task ID of “11”, which was divided from the task assigned the task ID of “1”, are “HostA” and “LDEV1” belonging to the resource group assigned with the resource group ID of “1”, the execution start time of that sub task was set to “2012 12/31/01:00”, and the execution end time of that sub task was set to “2012 12/31/03:00”.

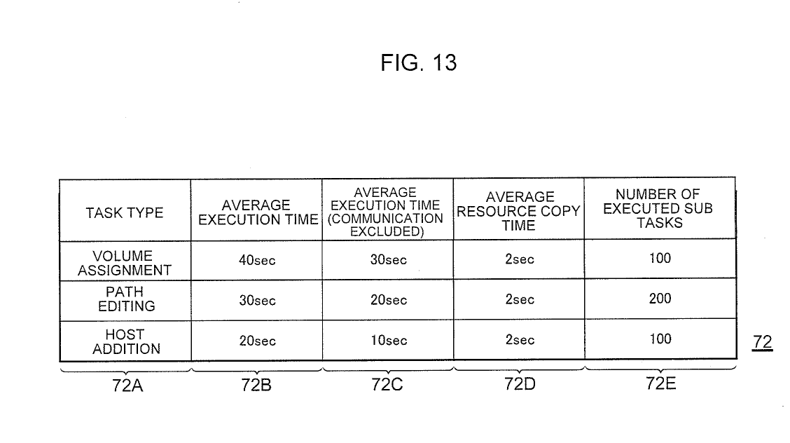

Moreover, the sub task average execution time management table 72 is a table that is used for managing the execution time for each type of sub task which was required for the execution of that sub task by the sub task execution unit 66, and is configured, as shown in FIG. 13, from a task type column 72A, an average execution time column 72B, an average execution time (communication excluded) column 72C, an average resource copy time column 72D and a number of executed sub tasks column 72E.

The task type column 72A stores the type of all sub tasks that were previously executed by the sub task execution unit 66, and the average execution time column 72B stores the average value of the execution time (average execution time) that was required for the sub task execution unit 66 to execute the corresponding type of sub tasks. Moreover, the average execution time (communication excluded) column 72C stores the average value of the time required only for executing the sub tasks, which excludes the communication with the aggregation server 5 and the other management servers 4, relative to the execution time that was required for the sub task execution unit 66 to execute the corresponding type of sub tasks including the foregoing communication. In addition, the average resource copy time column 72D stores the average value of the copy time required for acquiring the resource information required for executing the corresponding type of sub tasks from another management server 4, and copying the acquired resource information to the management server resource management table 70 in the own management server 4, and the number of executed sub tasks column 72E stores the number of times that the own management server 4 executed the corresponding type of sub tasks.

Accordingly, the example of FIG. 13 shows that, with regard to the sub task of the type indicated as “volume assignment”, the average execution time including the communication time with the aggregation server 5 and other management servers 4 is “40 sec”, the average execution time excluding the communication time is “30 sec”, the average value of the copy time required for copying the resource information required for executing that type of sub task from another management server 4 to the management server resource management table 70 in the own management server 4 is “2 sec”, and, heretofore, the own management server 4 has executed that type of sub task “100” times.

### (3) Various GUI Screens

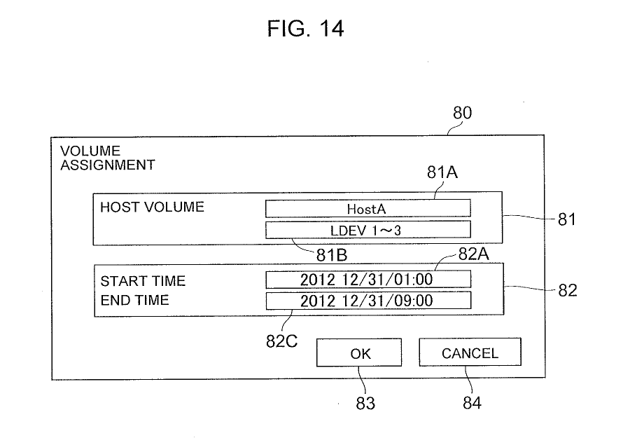

FIG. 14 shows a configuration example of the GUI screen to be displayed on the user terminal 9 by the GUI display information reception unit 51 of the aggregation server 5. This GUI screen (this is hereinafter referred to as the “volume assignment task setting screen”) 80 is a screen for setting the task of assigning logical volumes to the host computer 2, and is displayed on the output device of the user terminal 9 by the user using the user terminal 9 and accessing the aggregation server 5, and performing predetermined operations.

The volume assignment task setting screen 80 comprises a host/volume designation field 81 and an execution time designation field 82, an OK button 83, and a cancel button 84.

The host/volume designation field 81 is provided with a host designation column 81A and a volume designation column 81B, and the contents of the task can be set by inputting, in the host designation column 81A, the host ID of the host computer 2 to which the logical volumes are to be assigned, and inputting, in the volume designation column 81B, the volume ID of the logical volumes to be assigned to the host computer 2.

Moreover, the execution time designation field 82 is provided with a start time designation column 82A and an end time designation column 82B, and the execution time (start time and end time) of that task can be set by inputting the start time of the task in the start time designation column 82A, and inputting the end time of the task in the end time designation column 82B.

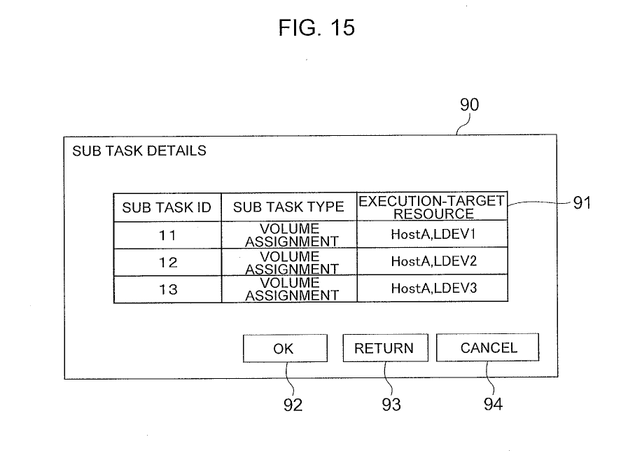

With the volume assignment task setting screen 80, the volume assignment task setting screen 80 can be closed without registering the task in the aggregation server 5 by clicking the cancel button 84, and switched to the detailed sub task screen 90 shown in FIG. 15 by clicking the OK button 83.

The detailed sub task screen 90 is a screen for presenting, to the user, how the task that was set on the volume assignment task setting screen 80 will actually be executed as an aggregate of sub tasks, and is configured, as shown in FIG. 15, from a sub task list 91, an OK button 92, a return button 93 and a cancel button 94.

In the foregoing case, the sub task list 91 will display the sub task information (sub task ID, sub task type and execution-target resource) of the respective sub tasks obtained by dividing the task that was set on the volume assignment task setting screen 80.

With the detailed sub task screen 90, the detailed sub task screen 90 can be closed without registering the task in the aggregation server 5 by clicking the cancel button 94, and returned to the volume assignment task setting screen 80 by clicking the return button 93.

Moreover, with the detailed sub task screen 90, the task that was set on the previous volume assignment task setting screen 80 can be registered in the aggregation server 5 by clicking the OK button 92. In effect, when the OK button 83 of the detailed sub task screen 90 is clicked, the task/sub task registration unit 52 (FIG. 6) stores, in the task management table 58 (FIG. 9), the task information of the task that was set on the previous volume assignment task setting screen 80, and registers, in the aggregation server sub task management table 59 (FIG. 10), the sub task information of the respective sub tasks that are listed in the sub task list 91 of the detailed sub task screen 90.

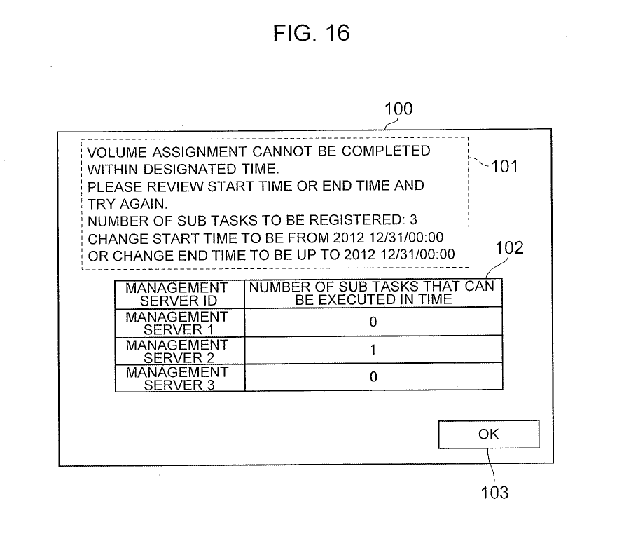

Meanwhile, FIG. 16 shows a configuration example of a warning screen 100 that is displayed on the output device of the user terminal 9 when a task is set on the volume assignment task setting screen 80 as described above and the OK button 92 of the detailed sub task screen 90 is thereafter clicked, but the aggregation server 5 determines that the task cannot be completed within the setup execution period of that task which was set by the user on the task setting screen 80.

The warning screen 100 is configured by comprising a warning message display field 101, a number of executable sub tasks list 102 and an OK button 103. The warning message display field 101 displays a warning message to the effect that the set task cannot be completed within the setup execution period, the number of sub tasks that were registered based on the task that was set by the user, and suggestions for changing the setting of the task. Moreover, the number of executable sub tasks list 102 lists the number of sub tasks that can be executed within the setup execution period of the original task for each of the management servers that are being managed by the aggregation server 5. The warning screen 100 can be closed by clicking the OK button 103.

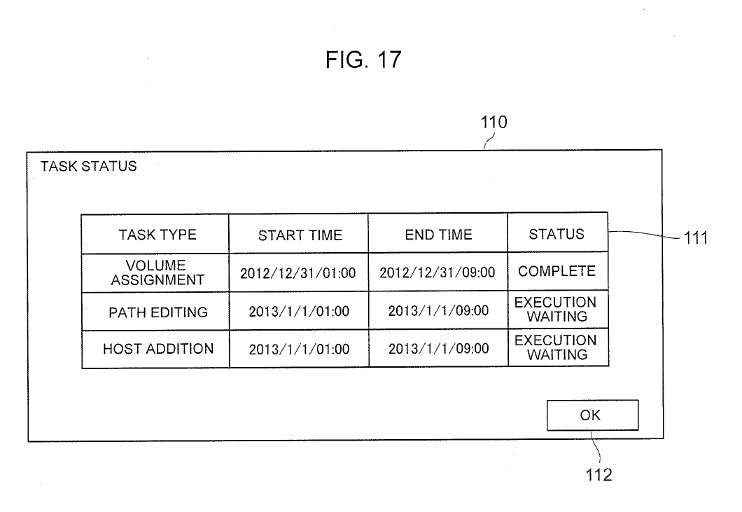

Meanwhile, FIG. 17 shows a task status screen 110 that is displayed on the output device of the user terminal 9 by the user using the user terminal 9 and accessing the aggregation server 5, and performing predetermined operations.

The task status screen 110 is a screen that is used by the user for confirming the status (execution status) of each of the set tasks, and is configured, as shown in FIG. 17, from a task execution state list 111 and an OK button 112. The task execution state list 111 lists the task type, start time, end time and status of the tasks that were completed within a predetermined time (for instance, within 24 hours), and tasks that have not yet been executed, among the respective tasks that were previously registered in the aggregation server 5 by the user. The task status screen 110 can be closed by clicking the OK button 112.

### (3) Various Types of Processing Related to Load Balancing Function According to this Embodiment

The processing contents of the various types of processing that are executed in relation to the load balancing function are now explained. Note that, while the processing entity of the various types of processing is described as a “program ( . . . unit)” in the ensuing explanation, it goes without saying that, in effect, the CPU 31, 51 of the management server 4 or the aggregation server 5 executes the processing based on that program.

### (3-1) Resource Information Acquisition Processing

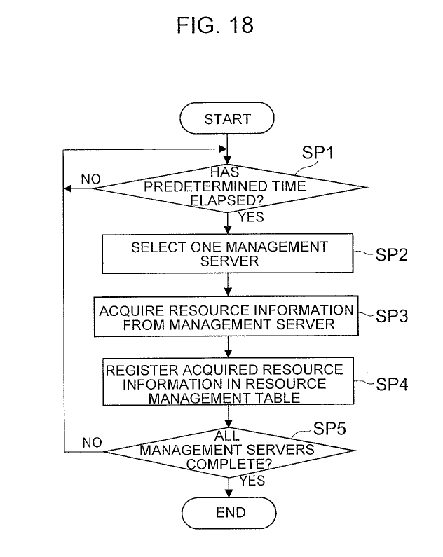

FIG. 18 shows the processing routine of the resource information acquisition processing to be executed by the management server information collection unit 50 (FIG. 6) of the aggregation server 5. According to the processing routine shown in FIG. 18, the management server information collection unit 50 acquires, from the respective management servers 4, the resource information of the respective resources (resource ID of the respective resources in this example) that are being managed by those management servers 4.

In effect, the management server information collection unit 50 starts the resource information acquisition processing when the power of the aggregation server 5 is turned on, and, foremost, the management server information collection unit 50 waits for a predetermined time (for instance, 10 minutes) to elapse as the interval of collecting the resource ID from the respective management servers 4 (SP1).

When the foregoing time has elapsed, the management server information collection unit 50 refers to the management server management table 56, and selects one unprocessed management server 4 among the management servers 4 that are being managed by the aggregation server 5 (SP2).

Subsequently, the management server information collection unit 50 acquires, from the management server management table 56, the IP address of the management server 4 selected in step SP2, accesses that management server 4 based on the acquired IP address, and acquires the resource ID of the respective resources that are being managed by that management server 4 (SP3).

Subsequently, the management server information collection unit 50 registers the acquired resource ID in the resource management table 57 (FIG. 8) (SP4), and thereafter determines whether the collection, from all management servers 4 registered in the management server management table 56, of the resource ID of the respective resources that are being managed by those management servers 4 is complete (SP5).

When the management server information collection unit 50 obtains a negative result in this determination, the management server information collection unit 50 returns to step SP1, and thereafter repeats the processing of step SP1 to step SP5 until a positive result is obtained in step SP5.

When the management server information collection unit 50 eventually obtains a positive result in step SP5 as a result of the collection, from all management servers 4 registered in the management server management table 56, of the resource ID of the respective resources that are being managed by those management servers 4 being completed, the management server information collection unit 50 ends this resource information acquisition processing.

### (3-2) Number of Inputtable Sub Tasks Confirmation Processing

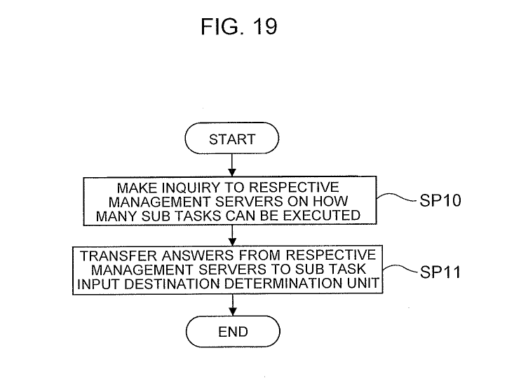

FIG. 19 shows the processing routine of the number of inputtable sub tasks confirmation processing to be executed by the number of inputtable sub tasks confirmation unit 53 (FIG. 6) of the aggregation server 5. According to the processing routine shown in FIG. 19, the number of inputtable sub tasks confirmation unit 53 makes an inquiry to the respective management servers 4 regarding how many sub tasks of the newly set task can be executed.

In effect, the number of inputtable sub tasks confirmation unit 53 starts the number of inputtable sub tasks confirmation processing shown in FIG. 19 when the sub task information of the respective sub tasks of the newly set task is provided from the task/sub task registration unit 52, sends the sub task information of the respective sub tasks to the respective management servers 4, and makes an inquiry to the respective management servers regarding how many of these sub tasks among the foregoing sub tasks can be executed within the setup execution period that was set for the original task (SP10).

Subsequently, the number of inputtable sub tasks confirmation unit 53 transfers, to the sub task input destination determination unit 54 (FIG. 6), the answers from the respective management servers 4 in response to the inquiry (inquiry on number of inputtable sub tasks) (SP11), and thereafter ends this number of inputtable sub tasks confirmation processing.

### (3-3) Number of Executable Sub Tasks Return Processing

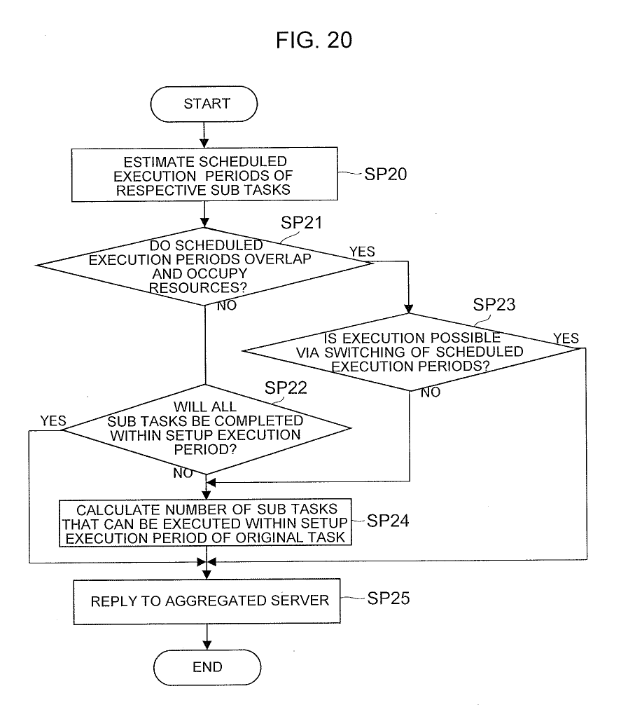

FIG. 20 shows the processing routine of the number of executable sub tasks return processing to be executed by the number of inputtable sub tasks return unit 64 of the management server 4 that received the foregoing inquiry on number of inputtable sub tasks. According to the processing routine shown in FIG. 20, the number of inputtable sub tasks return unit 64 confirms the number of sub tasks that the own management server 4 can execute within the setup execution period, and returns the confirmation result to the number of inputtable sub tasks confirmation unit 53.

In effect, the number of inputtable sub tasks return unit 64 starts the number of executable sub tasks return processing upon receiving the sub task information of the respective sub tasks that were divided from the newly set task, and the inquiry on number of inputtable sub tasks, and foremost refers to the sub task average execution time management table 72 (FIG. 13), and estimates the scheduled execution period of the individual sub tasks based on the type of each of the inquired sub tasks (this refers to the period from the start of execution to the end of execution of that sub task; hereinafter referred to as the “scheduled execution period”) (SP20).

Specifically, when the number of inputtable sub tasks return unit 64 possesses the resource information regarding each of the inquired sub tasks (this is hereinafter referred to as the “input-target sub task”) which is required for executing that input-target sub task, the number of inputtable sub tasks return unit 64 reads the average execution time of that type of sub task from the sub task average execution time management table 72, and uses the read average execution time as the estimated value of the execution time of the input-target sub task.

Moreover, when the number of inputtable sub tasks return unit 64 does not possess the resource information required for executing the input-target sub task, the number of inputtable sub tasks return unit 64 reads the average execution time of that type of sub task from the sub task average execution time management table 72, additionally reads the average copy time of the resource information required for executing that type of sub task from the sub task average execution time management table 72, and uses the total value of the read average execution time and average copy time as average copy time.

Subsequently, by adding the execution time of the respective input-target sub tasks estimated as described above, the number of inputtable sub tasks return unit 64 calculates the time required for sequentially executing the input-target sub tasks as the overall execution time of the newly set task, and estimates the scheduled execution period of the respective input-target sub tasks based on the calculation result.

Subsequently, the number of inputtable sub tasks return unit 64 refers to the management server sub task management table 71 (FIG. 12), and determines whether the scheduled execution period of any one of the input-target sub tasks obtained in step SP20 and the scheduled execution period of any one of the previously input sub tasks partially or entirely overlap, and whether that input-target sub task will perform an exclusive operation (lock) to a resource that is the same as the resource used by the previously input sub task (SP21).

When the number of inputtable sub tasks return unit 64 obtains a negative result in this determination, the number of inputtable sub tasks return unit 64 determines whether it is possible to complete the execution of all input-target sub tasks within the setup execution period of the original task based on the estimation result of step SP20 (SP22). Subsequently, when the number of inputtable sub tasks return unit 64 obtains a positive result in this determination, the number of inputtable sub tasks return unit 64 notifies the number of all inquired input-target sub tasks to the aggregation server 5 as the number of sub tasks that can be executed (SP25). The number of inputtable sub tasks return unit 64 thereafter ends this number of executable sub tasks return processing.

Meanwhile, when the number of inputtable sub tasks return unit 64 obtains a positive result in the determination of step SP22, the number of inputtable sub tasks return unit 64 detects the number of input-target sub tasks that can be executed within the setup execution period of the original task (SP24). Specifically, the number of inputtable sub tasks return unit 64 detects the number of sub tasks in which the execution thereof is estimated to be finished before the end time set for the original task as the number of sub tasks that can be executed within the setup execution period of the original task based on the scheduled execution period of the respective sub tasks estimated in step SP20.

Subsequently, the number of inputtable sub tasks return unit 64 returns this examination result to the aggregation server 5 (SP25), and thereafter ends this number of executable sub tasks return processing.

Meanwhile, when the number of inputtable sub tasks return unit 64 obtains a negative result in the determination of step SP21, the number of inputtable sub tasks return unit 64 determines whether all input-target sub tasks can be completed within the setup execution period of the original task by replacing the scheduled execution period of the input-target sub task in which the scheduled execution period is overlapping with the previously input sub task (this is hereinafter referred to as the “overlapping input-target sub task”) with the scheduled execution period of another input-target sub task (SP23).

Specifically, the number of inputtable sub tasks return unit 64 searches for another input-target sub target having the same estimated value of the scheduled execution period as the overlapping input-target sub task. Subsequently, the number of inputtable sub tasks return unit 64 replaces the scheduled execution period of the other input-target sub task that was detected in the foregoing search with the scheduled execution period of the overlapping input-target sub task.

Moreover, the number of inputtable sub tasks return unit 64 determines whether the lock of resources will overlap with the previously input sub task regarding the overlapping input-target sub task after the scheduled execution period has been replaced, and the other input-target sub task in which the scheduled execution period was replaced with the overlapping input-target sub task. Subsequently, the number of inputtable sub tasks return unit 64 determines that the overlapping input-target sub task can be executed when the lock of the resources does not overlap. In addition, when there is another overlapping input-target sub task, the number of inputtable sub tasks return unit 64 determines whether that overlapping input-target sub task can be executed according to the same method described above.

Subsequently, when the number of inputtable sub tasks return unit 64 obtains a determination result to the effect that all overlapping input-target sub tasks can be executed by replacing the scheduled execution period with another input-target sub task, the number of inputtable sub tasks return unit 64 proceeds to step SP25, and notifies the total number of inquired input-target sub tasks to the aggregation server 5 as the number of sub tasks that can be executed (SP25). The number of inputtable sub tasks return unit 64 thereafter ends this number of executable sub tasks return processing.

Meanwhile, when the lock of resources will overlap with the previously input sub task regarding at least one of the overlapping input-target sub task after the scheduled execution period has been replaced, and the other input-target sub task in which the scheduled execution period was replaced with the overlapping input-target sub task, the number of inputtable sub tasks return unit 64 performs the same determination upon switching the replacement destination of the scheduled execution period to another input-target sub task. Subsequently, the number of inputtable sub tasks return unit 64 repeats the same processing for all other input-target sub tasks until the overlapping-input target sub task can be executed based on the replacement of the scheduled execution period described above.

When there is an overlapping input-target sub task in which the scheduled execution period cannot be replaced with any of the other input-target sub tasks, the number of inputtable sub tasks return unit 64 detects the number of input-target sub tasks that can be executed within the setup execution period of the original task in the manner described above (SP24). Subsequently, the number of inputtable sub tasks return unit 64 returns this examination result to the aggregation server 5 (SP25), and thereafter ends this number of executable sub tasks return processing.

### (3-4) Sub Task Input Determination and Input Processing

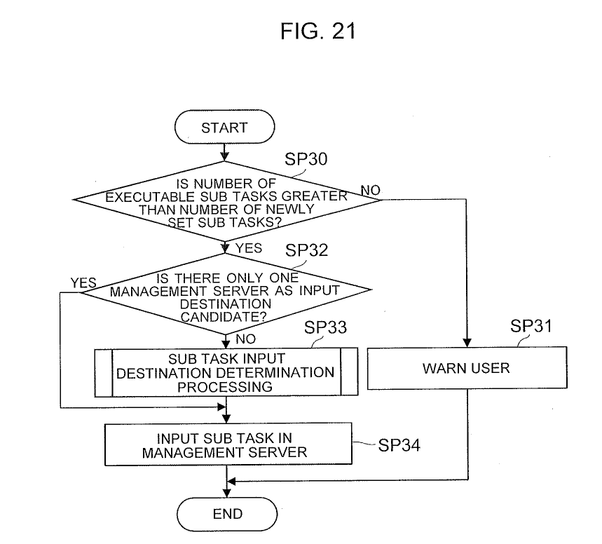

FIG. 21 shows the processing routine of the setup execution period to be executed by the sub task input destination determination unit 54 of the aggregation server 5. According to the processing routine shown in FIG. 12, the sub task input destination determination unit 54 determines the input destination of the respective sub tasks (respective input-target sub tasks) of the newly set task, and inputs the corresponding sub task in the determined input destination (sends the sub task information of that sub task and the execution request of that task).

In effect, the sub task input destination determination unit 54 starts the sub task input destination determination and input processing shown in FIG. 21 when the answer from the respective management servers 4 in response to the inquiry on number of inputtable sub tasks is transferred to the number of inputtable sub tasks confirmation unit 53, and foremost determines whether the total value of the number of executable sub tasks notified from the respective management servers 4 is greater than the number of sub tasks of the newly set task (SP30).

When the sub task input destination determination unit 54 obtains a negative result in this determination, the sub task input destination determination unit 54 notifies the GUI display information reception unit 51 to such effect. Consequently, the GUI display information reception unit 51 that received the foregoing notice displays the warning screen 100, which was explained with reference to FIG. 16, on the output device of the user terminal 9. The sub task input destination determination unit 54 thereafter ends this sub task input destination determination and input processing.

Meanwhile, when the sub task input destination determination unit 54 obtains a positive result in the determination of step SP30, the sub task input destination determination unit 54 determines whether only one management server 4 returned an answer to the effect that the sub task can be executed, and whether that management server 4 can execute all sub tasks of the newly set task (SP32).

When the sub task input destination determination unit 54 obtains a positive result in this determination, the sub task input destination determination unit 54 inputs all sub tasks of the newly set task into the management server 4 (SP34), and thereafter ends this sub task input destination determination and input processing.

Meanwhile, when the sub task input destination determination unit 54 obtains a negative result in the determination of step SP32, the sub task input destination determination unit 54 determines the input destination of the respective sub tasks of the newly set task so that the load of the respective management servers 4 is balanced (SP33), inputs these sub tasks into the corresponding management server 4 according to the determination result (SP34), and thereafter ends this sub task input destination determination and input processing.

Note that, on the side of the management server 4 to which the sub tasks were input, the sub task registration unit 65 (FIG. 6) registers the input sub task in the management server sub task management table 71 (FIG. 12), and requests the sub task execution unit 66 to execute those sub tasks. When the sub task execution unit 66 receives this request, the sub task execution unit 66 refers to the management server resource management table 70 and the management server sub task management table 71, determines whether the own management server 4 possesses the resource information required for executing those sub tasks, and, when the own management server 4 does not possess the resource information, sends a command to the resource copy unit 67 for copying the necessary resource information from another management server 4 (this is hereinafter referred to as the “resource copy command”). The processing contents of the resource copy unit 67 that received the foregoing resource copy command will be described later.

### (3-5) Sub Task Input Destination Determination Processing

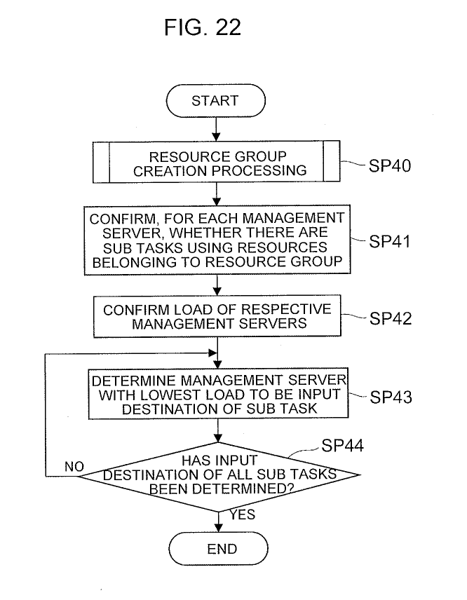

FIG. 22 shows the processing routine of the sub task input destination determination processing to be executed by the sub task input destination determination unit 54 in step SP33 of the sub task input destination determination and input processing described above with reference to FIG. 21.

The sub task input destination determination unit 54 starts the sub task input destination determination processing upon proceeding to step SP33 of the sub task input destination determination and input processing, and foremost creates a resource group obtained by grouping the resources required in the respective tasks of the newly set task, and registers the information of the created resource group (resource ID of the respective resources belonging to that resource group) in the resource group management table 60 (SP40).

Subsequently, the sub task input destination determination unit 54 refers to the resource management table 57 (FIG. 8), and confirms, for each management server 4, whether a sub task using the resources belonging to the resource group created in step SP40 has previously been input (SP41).

Moreover, the sub task input destination determination unit 54 confirms the load status of the respective management servers 4 that returned an answer to the effect that at least one or more sub tasks can be executed as the answer in response to the inquiry on number of inputtable sub tasks (SP42). Specifically, the sub task input destination determination unit 54 collects, from each of the target management servers 4, the average execution time of the sub tasks of the sub task type to be input at such time and which is stored in the sub task average execution time management table 72.

Subsequently, the sub task input destination determination unit 54 determines the management server 4 with the lowest load (that is, with the shortest average execution time collected in step SP42) as the input destination of one sub task among the target management servers 4 (SP43).

Here, in order to shorten the time required for that management server 4 to acquire resource information, which is required for executing the input sub task, from another management server 4, the sub task input destination determination unit 54 determines, according to the following priority, the sub task to be input into that management server 4 based on the confirmation result obtained in step SP41 and the resource management table 57.

1. In step SP41, when it is confirmed one of the sub tasks to use the resources belonging to the resource group that was created in step SP40 has been previously input into the management server (management server with the lowest load) 4, one of the sub tasks to use the resource in the resource group to which the resource used by that sub task belongs. When there are a plurality of such sub tasks, the sub task using the resource belonging to the resource group having the most common resources upon matching the resources belonging to the resource group that was created in step SP40, and the resources that are being managed by that management server 4.
2. Other sub tasks.

Note that, in step SP41, when it was not possible to confirm that one of the sub tasks to use the resources belonging to the resource group that was created in step SP40 has been previously input into the management server (management server with the lowest load) 4, there is no priority in the sub tasks to be input, and the sub task input destination determination unit 54 randomly determines the sub tasks to be input into the management server 4.

The sub task input destination determination unit 54 thereafter determines whether all of the sub tasks of the newly set task have been input into one of the management servers 4 (SP44). When the sub task input destination determination unit 54 obtains a negative result in this determination, the sub task input destination determination unit 54 returns to step SP43, and thereafter repeats the loop of step SP43-step SP44-step SP43 until a positive result is obtained in step SP44.

When the sub task input destination determination unit 54 eventually obtains a positive result in SP44 as a result of the input destination of all sub tasks of the newly set task being determined, the sub task input destination determination unit 54 thereafter ends this sub task input destination determination processing.

### (3-6) Resource Group Creation Processing

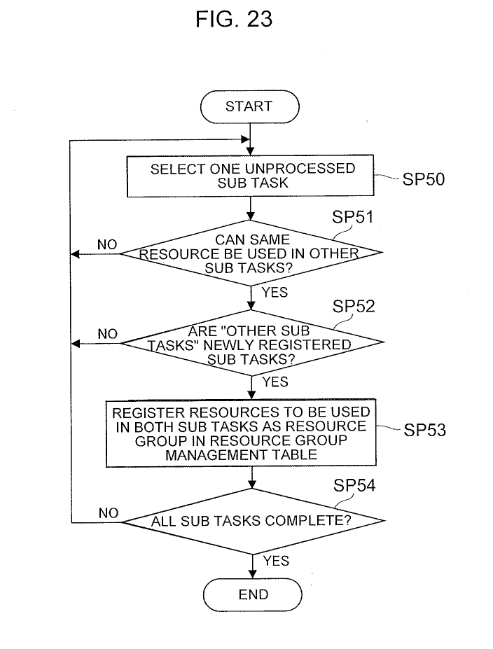

FIG. 23 shows the processing routine of the resource group creation processing to be executed by the sub task input destination determination unit 54 in step SP40 of the sub task input destination determination processing (FIG. 22) described above.

The sub task input destination determination unit 54 starts the resource group creation processing upon proceeding to step SP40 of the sub task input destination determination processing, and foremost selects one sub task, which has not yet been subject to the processing of step SP51 to step SP53, among the respective sub tasks of the newly set task (SP50).

Subsequently, the sub task input destination determination unit 54 determines whether there is a sub task using the same resource as the target sub task among the sub tasks other than the target sub task (SP51). When the sub task input destination determination unit 54 obtains a negative result in this determination, the sub task input destination determination unit 54 returns to step SP50.

Meanwhile, when the sub task input destination determination unit 54 obtains a positive result in the determination of step SP51, the sub task input destination determination unit 54 determines whether the sub task that was detected in step SP51 is a sub task of the newly set task (SP52). When the sub task input destination determination unit 54 obtains a negative result in this determination, the sub task input destination determination unit 54 returns to step SP50.

Meanwhile, when the sub task input destination determination unit 54 obtains a positive result in the determination of step SP52, the sub task input destination determination unit 54 registers, in the resource group management table 60 (FIG. 11), the resources used by both the target sub task and the sub task that was detected in step SP51, as a resource group (SP53).

Subsequently, the sub task input destination determination unit 54 determines whether the processing of step SP51 to step SP53 has been executed for all sub tasks of the newly set task (SP54). When the sub task input destination determination unit 54 obtains a negative result in this determination, the sub task input destination determination unit 54 returns to step SP50, and thereafter repeats the processing of step SP50 to step SP54 until a positive result is obtained in step SP54.

When the sub task input destination determination unit 54 eventually obtains a positive result in step SP54 as a result of the processing of step SP51 to step SP53 being executed for all sub tasks of the newly set task, the sub task input destination determination unit 54 thereafter ends this resource group creation processing.

### (3-7) Resource Information Copy Processing

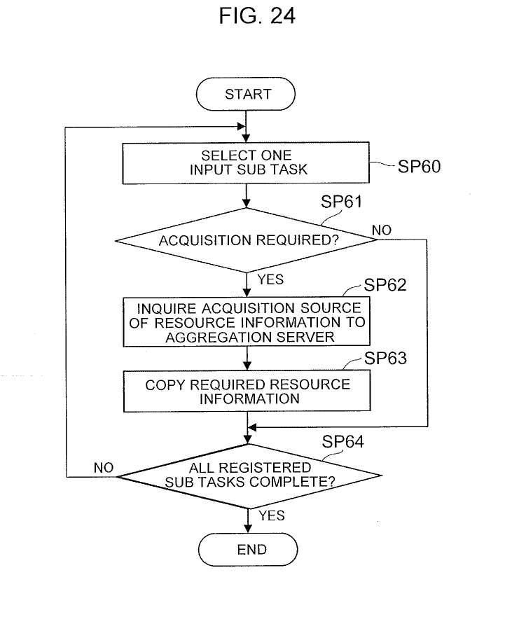

FIG. 24 shows the processing routine of the resource information copy processing to be executed by the resource copy unit 67 (FIG. 6) that received the foregoing resource copy command in step SP34 of the sub task input destination determination processing (22) described above. The resource copy unit 67 acquires the required resource information from another management server 4 according to this processing routine.

In effect, the resource copy unit 67 starts the resource information copy processing shown in FIG. 24 when the copy of resource information is requested from the sub task execution unit 66 (FIG. 6), and foremost selects one newly input sub task (SP60).

Subsequently, the resource copy unit 67 refers to the management server resource management table 70 and the management server sub task management table 71, and determines whether it is necessary to acquire the resource information of one of the resources in order to execute that sub task (SP61).

When the resource copy unit 67 obtains a negative result in this determination, the resource copy unit 67 proceeds to step SP64. Meanwhile, when the resource copy unit 67 obtains a positive result in this determination, the resource copy unit 67 makes an inquiry to the aggregation server 5 regarding from which management server the resource information to be acquired should be acquired (SP62). Consequently, here, the aggregation server 5 refers to the resource management table 57, selects another management server 4 that is retaining the inquired resource information (another management server 4 that is managing the corresponding resource), and notifies the access destination of the management server 4 as its answer to the resource copy unit 67.

Subsequently, the resource copy unit 67 accesses the corresponding other management server 4 and acquires the required resource information according to the answer from the aggregation server 5 in response to the inquiry of step SP62, and copies the acquired resource information to the management server resource management table 70 (SP63).

In addition, the resource copy unit 67 thereafter determines whether the processing of step SP61 to step SP63 has been executed for all of the newly input sub tasks (SP64). When the resource copy unit 67 obtains a negative result in this determination, the resource copy unit 67 returns to step SP60, and thereafter repeats the processing of step SP60 to step SP64 while sequentially switching the sub task that was selected in step SP64 to another unprocessed sub task.

When the resource copy unit 67 eventually obtains a positive result in step SP64 as a result of the processing of step SP61 to step SP63 being performed for all of the newly input sub tasks, the resource copy unit 67 thereafter ends this resource information acquisition processing.

### (4) Effect of this Embodiment

As described above, with the computer system 1 of this embodiment, since the task registered by the user is divided into a plurality of sub tasks in the aggregation server 5, and these sub tasks are input into a management server 4 with a low load, the load of the management servers 4 can be balanced according to the content of that task and in a unit that is smaller than that task.

Moreover, with the computer system 1, upon inputting the sub tasks into a management server 4 with a low load, since a resource group is created according to the resources that are used by each of the sub tasks, and, when one of the sub tasks to use the resource belonging to the resource group has previously been input to that management server 4, one of the sub tasks to use the resource in the resource group, to which the resource to be used by that sub task belongs, is determined as the sub task to be input into that management server 4, it is possible to shorten the time required for that management server 4 to acquire, from another management server 4, resource information that is required for executing the input sub tasks.

Consequently, according to the computer system 1 of this embodiment, the load of the management servers 4 can be dynamically and efficiently balanced.

### (5) Other Embodiments

While the foregoing embodiment explained a case of applying the present invention to a computer system configured as shown in FIG. 1, the present invention is not limited thereto, and can be broadly applied to other computer systems of various configurations that use a plurality of management servers to manage one or more storage apparatuses.

Moreover, while the foregoing embodiment explained a case of configuring the management server information collection unit 50, the GUI display information reception unit 51, the task/sub task registration unit 52, the number of inputtable sub tasks confirmation unit 53, the sub task input destination determination unit 54 and the sub task execution end reception unit 55 of the aggregation server 5, and the storage apparatus information collection unit 61, the host computer information collection unit 62, the management server management resource information send unit 63, the number of inputtable sub tasks return unit 64, the sub task registration unit 65, the sub task execution unit 66, the resource copy unit 67, the storage apparatus configuration information change unit 68 and the host computer configuration information change unit 69 of the management server 4 with software, the present invention is not limited thereto, and all a part of these components may also be configured with dedicated hardware.

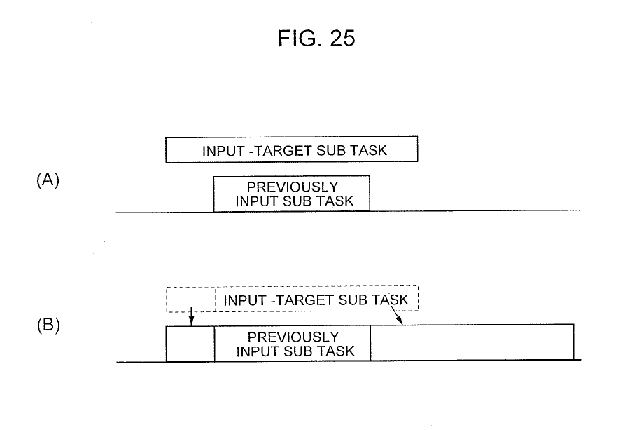

In addition, while the foregoing embodiment explained a case of estimating the scheduled execution period of the respective input-target sub tasks on the premise of sequentially executing the input-target sub tasks in step SP20 of the number of executable sub tasks return processing explained above with reference to FIG. 20, the present invention is not limited thereto, and, for example, when the execution of a previously input sub task within the setup execution period of the original task has already been scheduled as shown in FIG. 25(A), the scheduled execution time of the respective input-target sub tasks may be estimated on the premise of suspending the input-target sub tasks while the previously input sub task is being executed, and resuming the execution of the input-target sub tasks after the execution of the previously input sub task is completed as shown in FIG. 25(B).

### INDUSTRIAL APPLICABILITY

The present invention can be broadly applied to a computer system that uses a plurality of management servers to manage one or more storage apparatuses.

### REFERENCE SIGNS LIST

1 . . . computer system, 2 . . . host computer, 3 . . . storage apparatus, 4 . . . management server, 5 . . . aggregation server, 31, 41 . . . CPU, 50 . . . management server information collection unit, 51 . . . GUI display information reception unit, 52 . . . task/sub task registration unit, 53 . . . number of inputtable sub tasks confirmation unit, 54 . . . sub task input destination determination unit, 55 . . . sub task execution end reception unit, 56 . . . management server management table 56, 57 . . . resource management table, 58 . . . task management table, 59 . . . aggregation server sub task management table, 60 . . . resource group management table, 61 . . . storage apparatus information collection unit, 62 . . . host computer information collection unit, 63 . . . management server management resource information send unit, 64 . . . number of inputtable sub tasks return unit, 65 . . . sub task registration unit, 66 . . . sub task execution unit, 67 . . . resource copy unit, 68 . . . storage apparatus configuration information change unit, 69 . . . host computer configuration information change unit, 70 . . . management server resource management table, 71 . . . management server sub task management table, 72 . . . sub task average execution time management table, 80 . . . volume assignment screen, 90 . . . detailed sub task screen, 100 . . . warning screen, 110 . . . status screen.

1. A computer system including one or more storage apparatuses, comprising:
a plurality of management servers that are associated with the one or more storage apparatuses, and which manage resources of the associated storage apparatuses; and
an aggregation server that receives a task to be executed by the management servers,
wherein the aggregation server:
divides the received task into a plurality of sub tasks as a minimum unit of processing, makes an inquiry to each of the management servers regarding a number of the sub tasks, among the plurality of divided sub tasks, that can be executed between a start time and an end time that were set for the original task before being divided,
acquires, from each of the management servers that can execute at least one of the sub tasks, a load status of each of the management servers, and determines an input destination of each of the sub tasks so that the load of each of the management servers is balanced based on the acquired load status of each of the management servers and an answer from each of the management servers in response to the inquiry, and
inputs each of the sub tasks into the input destination management server according to a determination result,
wherein, when a management server does not possess resource information of the resource to be used by the sub task that was input from the aggregation server, that management server acquires resource information of the resource from the management server that is managing that resource, and thereafter executes the input sub task, and
wherein the aggregation server sequentially determines the management server with a lowest load as the input destination of the sub task upon determining the input destination of each of the sub tasks, manages all resources that are respectively used by the plurality of sub tasks that use a common resource as a resource group, and, when one of the sub tasks to use the resource belonging to the resource group has previously been input into the management server that was determined as the input destination of the sub task, one of the sub tasks to use the resource in the resource group, to which the resource to be used by that sub task belongs, is determined as the sub task to be input into that management server.

2. The computer system according to claim 1,
wherein each of the management servers:
manages an average execution time as an average value of an execution time for each type of the sub tasks, and
based on a type of the inquired sub task, refers to the average execution time of the sub task of that type, calculates the number of sub tasks that can be executed between the start time and the end time that were set for the task, and thereby provides an answer to the aggregation server.

3. The computer system according to claim 1,
wherein the aggregation server manages resources that are managed by each of the management servers, and
wherein, when a management server does not possess resource information of the resource to be used by the sub task that was input from the aggregation server, that management server causes the aggregation server to make an inquiry to the management server that is managing that resource, and acquires resource information of the resource from the management server that is managing that resource according to an answer from the aggregation server in response to the inquiry.

4. The computer system according to claim 1,
wherein each of the management servers manages an average execution time as an average value of an execution time for each type of the sub tasks, and
wherein the aggregation server:
acquires, from the target management server, the average execution time of a type of the sub task to be input as a load status of that management server, and
sequentially determines an input destination of each of the sub tasks with the management server, in which the average execution time is shortest, as the management server with the lowest load.

5. A load balancing method of balancing a load of management servers in a computer system including one or more storage apparatuses, and a plurality of management servers that are associated with the one or more storage apparatuses, and which manage resources of the associated storage apparatuses, wherein the computer system includes an aggregation server that receives a task to be executed by the management servers, and comprises:
a first step of the aggregation server dividing the received task into a plurality of sub tasks as a minimum unit of processing;
a second step of the aggregation server making an inquiry to each of the management servers regarding a number of the sub tasks, among the plurality of divided sub tasks, that can be executed between a start time and an end time that were set for the original task before being divided;
a third step of the aggregation server acquiring, from each of the management servers that can execute at least one of the sub tasks, a load status of each of the management servers, and determining an input destination of each of the sub tasks so that the load of each of the management servers is balanced based on the acquired load status of each of the management servers and an answer from each of the management servers in response to the inquiry;
a fourth step of the aggregation server inputting each of the sub tasks into the input destination management server according to a determination result; and
a fifth step of, when a management server does not possess resource information of the resource to be used by the sub task that was input from the aggregation server, that management server acquiring resource information of the resource from the management server that is managing that resource, and thereafter executing the input sub task,
wherein, in the third step,
the aggregation server sequentially determines the management server with a lowest load as the input destination of the sub task upon determining the input destination of each of the sub tasks, manages all resources that are respectively used by the plurality of sub tasks that use a common resource as a resource group, and, when one of the sub tasks to use the resource belonging to the resource group has previously been input into the management server that was determined as the input destination of the sub task, one of the sub tasks to use the resource in the resource group, to which the resource to be used by that sub task belongs, is determined as the sub task to be input into that management server.

6. The load balancing method according to claim 5,
wherein each of the management servers manages an average execution time as an average value of an execution time for each type of the sub tasks, and
wherein, in the second step, based on a type of the inquired sub task, each of the management servers refers to the average execution time of the sub task of that type, calculates the number of sub tasks that can be executed between the start time and the end time that were set for the task, and thereby provides an answer to the aggregation server.

7. The load balancing method according to claim 5,
wherein the aggregation server manages resources that are managed by each of the management servers, and comprises:
a fifth step of, when a management server does not possess resource information of the resource to be used by the sub task that was input from the aggregation server, that management server causing the aggregation server to make an inquiry to the management server that is managing that resource; and
a sixth step of the management server acquiring resource information of the resource from the management server that is managing that resource according to an answer from the aggregation server in response to the inquiry.

8. The load balancing method according to claim 5,
wherein each of the management servers manages an average execution time as an average value of an execution time for each type of the sub tasks, and
wherein, in the third step, the aggregation server:
acquires, from the target management server, the average execution time of a type of the sub task to be input as a load status of that management server, and
sequentially determines an input destination of each of the sub tasks with the management server, in which the average execution time is shortest, as the management server with the lowest load.
